(19) United States
(12) Patent Application Publication
(10) Pub. No.: US 2003/0000211 A1
(43) Pub. Date: Jan. 2, 2003

(54) Method for driving an internal-combustion engine and an internal-combustion engine

(75) Inventors: Hans Drangel, Stockholm (SE); Hans Karlsson, Jarfalla (SE); Anders Larsen, Nykvarn (SE); Henrik Nordin, Sundsvall (SE)

Correspondence Address: OSTROLENK FABER GERB & SOFFEN, 1180 AVENUE OF THE AMERICAS, NEW YORK, NY, 100368403

(73) Assignee: Saab Automobile AB

(21) Appl. No.: 10/188,262

(22) Filed: Jul. 1, 2002

(30) Foreign Application Priority Data
Jun. 29, 2001 (SE) 0102338-1

(51) Int. Cl. F02D 23/00

(52) U.S. Cl. 60/602

(57) ABSTRACT

In an internal-combustion engine having an exhaust-gas driven supercharger (8) and having at least two exhaust-gas valves (2, 3) per cylinder, a first exhaust-gas valve (2) in each cylinder is connected to a first exhaust manifold (4), whilst a second exhaust-gas valve (3) in each cylinder is connected to a second exhaust manifold (5). The two exhaust manifolds (4, 5) lead to at least one exhaust-gas turbine in at least one turbo compressor and the first exhaust-gas valves (2) are arranged to be opened at all engine speeds, whilst the second exhaust-gas valves (3) are arranged to be opened only at higher engine speeds. The first exhaust manifold (4) has a smaller flow area than the second exhaust manifold (5). By choosing which exhaust-gas valves are to be used, the size of the flow ducts between engine and exhaust-gas turbine can easily be suited to the size of the exhaust-gas flow which is available at the time.

### TECHNICAL FIELD

The invention relates firstly to a method for driving an internal-combustion engine, according to the preamble of Patent claim 1, and secondly to an internal-combustion engine, according to the preamble of Patent claim 5.

### PRIOR ART

In turbo engines having an exhaust-gas-driven turbo compressor, the performance of the engine is largely dependent on the working range of the turbo compressor. The exhaust-gas turbine of the turbo compressor and the exhaust-gas ducts leading thereto are usually dimensioned for the high exhaust-gas flows which are generated at high revs and high engine loads. This means, however, that at lower revs and with smaller exhaust-gas flows, exhaust-gas energy is lost en route to the exhaust-gas turbine, thereby impairing the effectiveness of the turbo compressor.

In order to be able to achieve good performance of the turbo compressor at low revs, it is desirable to use a small turbine and small dimensions on the pipes thereto with a view to reducing energy losses. This creates disadvantages, however, in respect of high exhaust-gas flows, since the small dimensions result in a throttling of the exhaust-gas flow and high counter-pressure in the exhaust-gas pipe, with accompanying air-supply problems.

In four-cylinder turbo engines, in particular, it is known to use exhaust-gas turbines having dual, equal-sized inlets and to connect two cylinders to each inlet, the cylinders being connected in such a way that an intake cylinder is always separated from an exhaust-gas-delivery cylinder. In the case of a four-cylinder in-line engine, the two outer cylinders-are therefore normally connected to the same turbine inlet, whilst the two centremost cylinders are connected to another turbine inlet. In order to obtain the required adjustability, there is a waste gate valve disposed in each inlet, which adds to the complexity of the turbine. The two inlet ducts to the exhaust-gas turbine here have the same sizes, designed for a large exhaust-gas flow, with accompanying loss of efficiency at low revs and small exhaust-gas flows.

In the light of this, improved solutions are needed in terms of exhaust-gas delivery to the exhaust-gas turbine.

### OBJECT OF THE INVENTION

The object of the invention is to achieve an improved exhaust-gas delivery to the exhaust-gas turbine. Another object is to achieve a simple solution.

### ACCOUNT OF THE INVENTION

The object of the invention is achieved firstly by the use of a method for driving an internal-combustion engine, having special features according to Patent claim 1, and secondly by the use of an internal-combustion engine having special features according to Patent claim 5.

By, in each cylinder, splitting the exhaust-gas delivery amongst valves which can be activated differently, it becomes possible, at low revs, to make all delivery to the exhaust-gas turbine occur via only one valve in the cylinders and via narrower pipes than at high revs, whilst at the same time using an exhaust-gas turbine of limited size. At high revs and large exhaust-gas flow, on the other hand, all exhaust-gas valves and larger ducts are used to drive a sufficiently large exhaust-gas turbine.

The exhaust-gas turbine can expediently in this case have dual inlets, namely an inlet which is used at all revs and another inlet which is used as a supplement at high revs. Another possibility is to use two separate exhaust-gas turbines, namely a small one which is always connected and a larger one which is connected only at high revs and large exhaust-gas flows.

By thus controlling the exhaust-gas delivery as a function of the engine speed and size of the exhaust-gas flow, it becomes possible to use a size of exhaust-gas turbine and inlet ducts thereof which is better suited to the particular operating situation.

Further special features and advantages in respect of solutions according to the invention can be seen from the description and other patent claims.

The invention is explained in greater detail below with reference to illustrative embodiments shown in the appended drawing.

### DESCRIPTION OF THE FIGURES

In the drawing:

FIG. 1 shows an internal-combustion engine according to the invention provided with an exhaust-gas-driven supercharger,

FIG. 2-3 show a section through an embodiment of an exhaust-gas turbine in various working positions,

FIG. 4 shows a section through another embodiment of an exhaust-gas turbine, and

FIG. 5 shows a variant of the supercharger shown in FIG. 1.

### DESCRIPTION OF ILLUSTRATIVE EMBODIMENTS

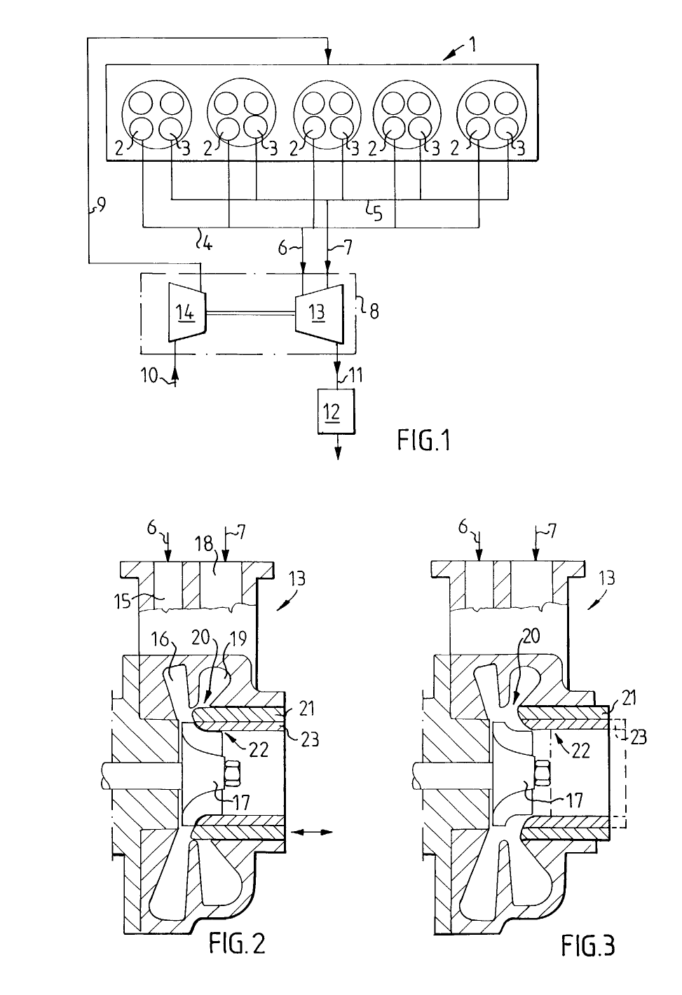

FIG. 1 shows in diagrammatic representation an Otto-type multi-cylinder internal-combustion engine 1 realized according to the invention. The engine cylinders each have at least two exhaust-gas valves 2, 3, in which a first exhaust-gas valve 2 in each cylinder is connected to a first exhaust manifold 4, and in which a second exhaust-gas valve 3 in each cylinder is connected to a second exhaust manifold 5. The two exhaust manifolds 4, 5 emerge via respectively a first exhaust-gas pipe 6 and a second exhaust-gas pipe 7 into a supercharger 8, by means of which charge air is fed to the engine 1 via an air pipe 9 in a known manner (not shown here in greater detail). The supercharger 8 driven by exhaust gases from the engine is provided with air via an inlet 10 and has an exhaust-gas outlet 11 intended for the exhaust gases, whence the exhaust gases are led away from the engine in the conventional manner via a catalyser 12 and other conventional components (not shown here in greater detail) in the engine's exhaust system.

The supercharger 8 can be realized in a number of different ways, some of which are described below. In the case of the realization shown in FIG. 1, the supercharger 8 is constituted by a single turbo compressor having an exhaust-gas turbine 13 and a compressor 14 driven by the latter. The two exhaust-gas pipes 6 and 7 here emerge into one and the same exhaust-gas turbine 13.

The more detailed realization of such an exhaust-gas turbine 13 can be seen from FIG. 2-3. A first inlet 15, into which the first exhaust-gas pipe 6 emerges, leads to a first duct 16 from which exhaust gases can reach the turbine wheel 17 of the exhaust-gas turbine in order to drive it. Correspondingly, a second inlet 18, into which the second exhaust-gas pipe 7 emerges, leads to a second duct 19 from which exhaust gases can reach the turbine wheel 17. For regulation of the exhaust-gas flow from the second duct 19 to the turbine wheel 17, there is a valve 20, in which a tubular valve body 21 is axially displaceable and can thereby alter the opening extent of the valve from a closed position shown in FIG. 2 to a fully open position shown in FIG. 3. Radially within the valve 20 there is a waste gate valve 22, in which a tubular valve body 23 is axially displaceable from a closed position represented by continuous lines to an open position represented in FIG. 3 by dashed lines, in which a desired proportion of the exhaust gases can pass by the turbine wheel 17 without driving it, thereby serving to regulate the compressor 14.

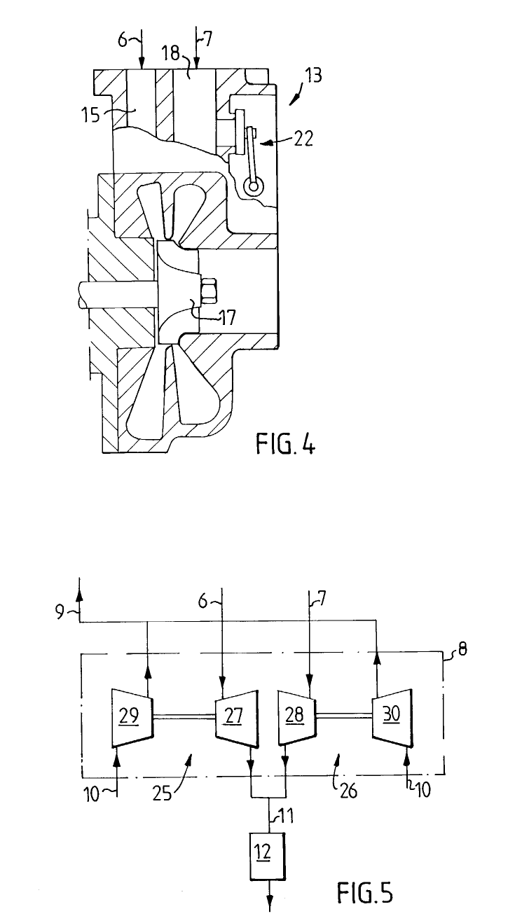

In FIG. 4 an exhaust-gas turbine 13 is shown of a somewhat different realization than in FIG. 2-3. As previously, there is a first inlet 15 connected to the first exhaust-gas pipe 6, and a second inlet 18 connected to the second exhaust-gas pipe 7. A conventional-type waste gas valve 22 is here placed in the second, larger inlet 18 and can be opened in order to reduce the exhaust-gas flow to the turbine wheel 17. This waste gate valve 22 might instead be placed in the first, smaller inlet 15 or such a waste gate valve can also be present in each of the two inlets 15, 18.

The engine 1 described in FIG. 1-4 functions as follows. The first exhaust-gas valves 2 are arranged to be constantly in operation, whereas the second exhaust-gas valves 3 are arranged to operate only at high revs and at large exhaust-gas flows. This is achieved by the second exhaust-gas valves 3 being driven by means of a mechanism in which the valves can be activated and deactivated as desired. A large number of such mechanisms are now commercially available to the person skilled in the art, and therefore a more detailed description of a realization is not provided in this connection. At low revs and small exhaust-gas flows, only the first exhaust-gas valves 2 are therefore operative. In order to limit energy losses in the exhaust gases delivered via the first exhaust-gas valves 2, the pipe dimensions from these valves and up to and into the exhaust-gas turbine 13 via its first inlet 15 are relatively small. Once the engine speed and the load have risen to a predefined level, the second exhaust-gas valves 3 and the valve 20 are also activated in order to provide the exhaust-gas turbine 13 with more exhaust gases. In order to handle this increased exhaust-gas flow, the pipe dimensions from the second exhaust-gas valves 3 up to and into the exhaust-gas turbine 13 via its second inlet 18 can be larger than from the first exhaust-gas valves 2. When required, the charge pressure of the compressor 14 can be adjusted by manoeuvring the waste gate valve 22 and thereby causing a desired quantity of exhaust gases to be led past the gas turbine without driving it.

The adjustability of the second exhaust-gas valves 3 also makes it possible to have for these valves a different length of opening than for the first exhaust-gas valves 2. By causing the second exhaust-gas valves 3 to have a longer, and possibly larger retained opening than the first exhaust-gas valves 2, a very effective exhaust-gas delivery at high load and high revs is made possible.

A variant of a supercharger 8 is shown in FIG. 5. The first exhaust-gas pipe 6 is here connected to a dedicated turbo compressor 25 and also the second exhaust-gas pipe 7 is connected to a dedicated turbo compressor 26, which can be larger than the turbo compressor 25 so as to be able to handle larger exhaust-gas flows. From an exhaust-gas turbine 27 in the first turbo compressor 25 and an exhaust-gas turbine 28 in the second turbo compressor 26, the exhaust gases are delivered to the exhaust-gas outlet 11. Similarly, air is fed from compressors 29 and 30, in which the latter can be larger than the former, to the air pipe 9 and from there to the engine. The two turbo compressors 25 and 26 are here expediently of standard realization, but as has been made clear, possibly of different sizes. The one or both can in a conventional manner have a waste gate valve for regulating the charge pressure.

When a supercharger 8 of the type shown in FIG. 1-4 and in which the exhaust-gas turbine 13 thus has dual inlets is combined with a four-cylinder engine, it becomes possible to utilize the special characteristics of such an engine in order to obtain an advantageous blow-cleaning of the cylinders at low revs and high load. This is achieved by making also the first exhaust-gas valves 2 capable of being activated and deactivated and by, at low revs, causing the two outer cylinders to be connected via their respective first exhaust-gas valve 2 to the first inlet 15, whilst the two middle cylinders are instead connected to the second inlet 18 through the closure of the first exhaust-gas valve 2 in these cylinders and the opening of the second exhaust-gas valve 3. In the event of a change to other operating conditions, the retained opening of the exhaust-gas valves 2 and 3 in the two middle cylinders can subsequently be altered so that it becomes the same as for the two outer cylinders.

As a result of the ability to activate and deactivate different exhaust-gas valves in different ways, the operating conditions for an engine can thus be influenced in a wide variety of ways, according to requirement and wishes.

1. Method for driving a multi-cylinder internal-combustion engine having an exhaust-gas driven supercharger (8) and having at least two exhaust-gas valves (2, 3) per cylinder, in which exhaust gases are delivered, on the one hand, to a first exhaust manifold (4) via a first exhaust-gas valve (2) in each cylinder and, on the other hand, to a second exhaust manifold (5) via a second exhaust-gas valve (3) in each cylinder, characterized in that at low revs only the first exhaust-gas valves (2) are opened, whilst at high revs both the first (2) and the second (3) exhaust-gas valves are opened, and in that the exhaust gases are led to at least one exhaust-gas turbine in at least one turbo compressor.

2. Method according to claim 1, characterized in that exhaust gases from the first (4) and the second (5) exhaust manifold are led to different inlets (15, 18) in the same exhaust-gas turbine (13).

3. Method according to claim 1, characterized in that exhaust gases from the first (4) and the second (5) exhaust manifold are led to two different exhaust-gas turbines (27, 28) in two different turbo compressors (25, 26).

4. Method according to any of claims 1-3, characterized in that a larger exhaust-gas flow is led through the second exhaust manifold (5) than through the first exhaust manifold (4).

5. Internal-combustion engine having an exhaust-gas driven supercharger (8) and having at least two exhaust-gas valves (2, 3) per cylinder, a first exhaust-gas valve (2) in each cylinder being connected to a first exhaust manifold (4) and a second exhaust-gas valve (3) in each cylinder being connected to a second exhaust manifold (5), characterized in that the exhaust manifolds (4, 5) are connected to at least one exhaust-gas turbine in at least one turbo compressor and in that the first exhaust-gas valves (2) are arranged to be opened at all engine speeds, whilst the second exhaust-gas valves (3) are arranged to be opened only at higher engine speeds.

6. Internal-combustion engine according to claim 5, characterized in that the second exhaust manifold (5) has a larger cross-sectional area than the first exhaust manifold (4) for a larger exhaust-gas flow than the first exhaust manifold.

7. Internal-combustion engine according to claim 5 or 6, characterized in that the first (4) and the second (5) exhaust manifold feed their respective exhaust-gas turbine (27, 28) in two separate turbo compressors (25, 26).

8. Internal-combustion engine according to claim 5 or 6, characterized in that the first (4) and the second (5) exhaust manifold are connected to the same exhaust-gas turbine (13) via their respective inlet (15,18) in this.

9. Internal-combustion engine according to claim 8, characterized in that in at least one of the inlets (15, 18) there is a waste gate valve (22) for adjusting the exhaust-gas flow to a turbine wheel (17).

10. Internal-combustion engine according to claim 9, characterized in that next to the turbine wheel (17) there is a waste gate valve (22) which is common to two ducts (16, 19) connected to the two inlets (15, 18).
